(19) United States
(12) Patent Application Publication
(10) Pub. No.: US 2017/0336064 A1
(43) Pub. Date: Nov. 23, 2017

(54) ACCESSORY HOLDER FOR RAILING SYSTEM

(71) Applicant: Peak Innovations Inc., Richmond (CA)

(72) Inventors: WALKER SIMON, Delta (CA); LAWSON CRAIG, Burnaby (CA); YOUNG CHARLES, Vancouver (CA); FAN HOU JUN, Surrey (CA)

(73) Assignee: Peak Innovations Inc., Richmond (CA)

(21) Appl. No.: 15/534,347

(22) PCT Filed: Nov. 5, 2015
(86) PCT No.: PCT/CA2015/051144

§ 371 Date: Jun. 8, 2017

Related U.S. Application Data
(60) Provisional application No. 62/202,584, filed on Aug. 7, 2015.

(30) Foreign Application Priority Data
Dec. 11, 2014 (CA) PCT/CA2014/000888

(51) Int. Cl. F21V 33/00; F21S 4/28; F21V 21/02; E04F 11/18; F21Y 103/00; F21W 111/08

(52) U.S. Cl. CPC F21V 33/006; F21V 21/025; E04F 11/1836; F21S 4/28; E04F 2011/1872; F21W 2111/08; F21Y 2103/00

(57) ABSTRACT

An accessory holder for securing an accessory (such as a light strip) on a structure comprises a rail and a cap. The rail comprises a planar portion and two surfaces extending from the planar portion. The cap comprises an attachment portion and a cover. The accessory is held within a compartment defined by the planar portion, the two surfaces, and the cover. The attachment portion attaches the cap to the rail by engaging with ridges located on the interior faces of the surfaces.

### FIELD OF THE INVENTION

The invention relates to the field of railings, and in particular, to an attachment to a railing for holding accessories, such as light strips.

### BACKGROUND OF THE INVENTION

Railing systems for any number of outdoor applications are well-known. For example, residential decks, pool decks, playgrounds all utilize any number of conventional railing systems. A conventional railing system typically comprises one or more elongated railings, with one or both ends of the railings supported by generally vertical posts. The posts and the railings may be attached together using a variety of connectors or fasteners. One exemplary railing system is the RailBlazers® system manufactured by Peak Innovations Inc. and generally disclosed in U.S. Pat. No. 7,677,000 to Walker. This railing system comprises upper and lower aluminum railings with vertical aluminum posts on either ends of the railings. The posts comprise an open-ended head and a lower rail support to snugly receive the upper and lower railings, respectively. One or more vertical pickets may span the upper and lower railings.

It may sometimes be desirable to incorporate accessories (e.g. illumination) to a railing system. For example, illumination may provide a safety benefit by increasing visibility around the railing system, especially at night. Alternatively, illumination may increase the overall aesthetic appeal of the railing system. Other accessories may include hangers for ornaments or other decorative features.

### SUMMARY OF THE INVENTION

An accessory holder for securing an accessory (such as a light strip) on a structure comprises a rail and a cap. The rail comprises a planar portion and two surfaces extending from the planar portion. The cap comprises an attachment portion and a cover. The accessory is held within a compartment defined, at least in part, by the planar portion, the two surfaces, and the cover. The attachment portion attaches the cap to the rail by engaging with ridges located on the interior faces of the surfaces.

In one embodiment of the invention, an apparatus for securing an accessory to a structure comprises first and second elongated members. The first elongated member comprises a planar portion and a plurality of surfaces extending from the planar portion. The planar portion comprises one or more openings adapted to receive fasteners for attachment of the planar portion to the structure. Each of the surfaces comprises a substantially longitudinal ridge. The planar portion and the surfaces define a channel, and the ridges extend inwardly into the channel. The second elongated member is fitted in the channel and comprises a cover and an attachment portion. The attachment portion comprises a plurality of attachment surfaces attached to the cover, with each of the attachment surfaces being contoured to engage with one of the ridges. The first and second elongated members define a compartment for holding the accessory. The compartment is defined, at least in part, by the planar portion, the surfaces, and the cover.

In another embodiment of the invention, the planar portion further comprises two substantially longitudinal edges, with the surfaces extending from the longitudinal edges.

In yet another embodiment of the invention, the planar portion further comprises two substantially longitudinal edges, with the surfaces extending a distance away from the longitudinal edges.

In still yet another embodiment of the invention, the first elongated member is made from metal.

In a further embodiment of the invention, the second elongated member is made from plastic.

In yet a further embodiment of the invention, the first elongated member is made from a first material and the second elongated member is made from a second material. The second material is more pliable than the first material.

In still yet a further embodiment of the invention, the surfaces extend substantially perpendicularly from the planar portion.

In another embodiment of the invention, each of the surfaces comprise an upper edge and a lower edge, with the ridge extending in between the upper and lower edges.

In still another embodiment of the invention, the ridges on opposing surfaces are aligned with each other.

In yet still another embodiment of the invention, the surfaces further comprise an upper shelf extending into the channel. The upper shelf extends from the surface in between the upper edge and the ridge.

In a further embodiment of the invention, the upper shelves extend substantially parallel to the planar portion.

In still a further embodiment of the invention, the upper shelves on opposing surfaces are aligned with each other.

In still yet a further embodiment of the invention, the surfaces further comprise one or more protrusions extending substantially parallel to the ridges and extending into the channel.

In another embodiment of the invention, the protrusions on opposing surfaces are aligned with each other.

In still another embodiment of the invention, the cover is at least partially translucent.

In yet still another embodiment of the invention, the cover is at least partially transparent.

In yet another embodiment of the invention, the attachment surfaces slidably engage with the ridges.

In a further embodiment of the invention, each of the attachment surfaces comprises one or more bends.

In still a further embodiment of the invention, the attachment surfaces are adapted to bend inwardly when a force substantially perpendicular to a longitudinal axis of the second elongated member is applied on the attachment surfaces.

In still yet a further embodiment of the invention, the attachment surfaces are adapted to revert to an original orientation when the force is no longer applied.

In another embodiment of the invention, the attachment surfaces comprise a lower shelf extending into the channel.

In yet another embodiment of the invention, the lower shelves on opposing attachment surfaces are aligned with each other.

In still another embodiment of the invention, the attachment surfaces extend substantially perpendicularly from the cover.

In still yet another embodiment of the invention, the cover comprises two longitudinal ends, and the attachment surfaces extend from the cover at a distanced away from the longitudinal ends.

In a further embodiment of the invention, the cover further comprises a ledge extending proximate to each of the longitudinal ends.

In yet a further embodiment of the invention, the ledge is in contact with the surface.

In still yet a further embodiment of the invention, the cover is flat.

In yet another embodiment of the invention, the cover is curved.

In still yet another embodiment of the invention, the ridge engages a portion of the attachment surface and a portion of the cover.

In another embodiment of the invention, a holder of a light strip for a railing comprises a rail and a cap. The rail comprises a planar portion and a plurality of surfaces extending from the planar portion. The planar portion comprises one or more openings adapted to receive fasteners for attachment of the planar portion to the railing. Each of the surfaces comprises a substantially longitudinal ridge. The planar portion and the surfaces define a channel, and the ridges extend inwardly into the channel. The cap is fitted in the channel and comprises a cover and an attachment portion. The attachment portion comprises a plurality of attachment surfaces attached to the cover, with each of the attachment surfaces being contoured to engage with one of the ridges. The rail and the cap define a compartment for holding the light strip. The compartment is defined, at least in part, by the planar portion, the surfaces, and the cover.

In a further embodiment of the invention, an apparatus for securing an accessory to a structure comprises first and second elongated members. The first elongated member comprises a planar portion and a plurality of surfaces extending from the planar portion. The planar portion comprises one or more openings adapted to receive fasteners for attachment of the planar portion to the structure. Each of the surfaces comprises upper and lower edges and a substantially longitudinal ridge extending in between the upper and lower edges. The planar portion and the surfaces define a channel, and the ridges extend inwardly into the channel. The second elongated member is fitted in the channel and comprises a slot portion and an attachment portion. The slot portion comprises a slot for holding the accessory, with the slot being at least partially open on one side. The attachment portion comprises a plurality of attachment surfaces. Each of the attachment surfaces is contoured to engage with one of the ridges, and the attachment surfaces are attached to the slot portion.

In yet a further embodiment of the invention, the slot portion further comprises a slot upper wall and one or more slot side walls extending from the slot upper wall.

In still yet a further embodiment of the invention, the slot portion further comprises one or more lips. The lips extend away from the slot side walls and inwardly into the channel.

In another embodiment of the invention, the ridges are in contact with at least a portion of at least one of the attachment surfaces and with at least a portion of the slot upper wall.

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

The preferred embodiment of the invention will be described by reference to the drawings thereof, in which:

FIG. 1 is a front view showing an accessory holder in accordance with an embodiment of the present invention, as attached to a railing system;

FIG. 2 is a partial bottom view showing the accessory holder of FIG. 1 attached to the railing system;

FIG. 3 is a partial perspective view showing the accessory holder of FIG. 1 attached to the railing system;

FIG. 4 is a perspective view of the accessory holder of FIG. 1;

FIG. 5 is an exploded perspective view of the accessory holder of FIG. 1;

FIG. 6 is an elevational view of the accessory holder of FIG. 1, showing the insertion of the cap onto the rail;

FIG. 7 is an elevational view of the accessory holder of FIG. 1, with the cap inserted onto the rail;

FIG. 8 is an embodiment of the accessory holder of FIG. 1, holding a light strip;

FIG. 9 is a perspective view of another embodiment of the accessory holder;

FIG. 10 is an exploded perspective view of the accessory holder of FIG. 9;

FIG. 11 is an elevational view of the accessory holder of FIG. 9, showing the insertion of the cap onto the rail;

FIG. 12 is an elevational view of the accessory holder of FIG. 9, with the cap inserted onto the rail; and

FIG. 13 is an embodiment of the accessory holder of FIG. 9, holding a light strip.

### DETAILED DESCRIPTION OF THE DRAWINGS

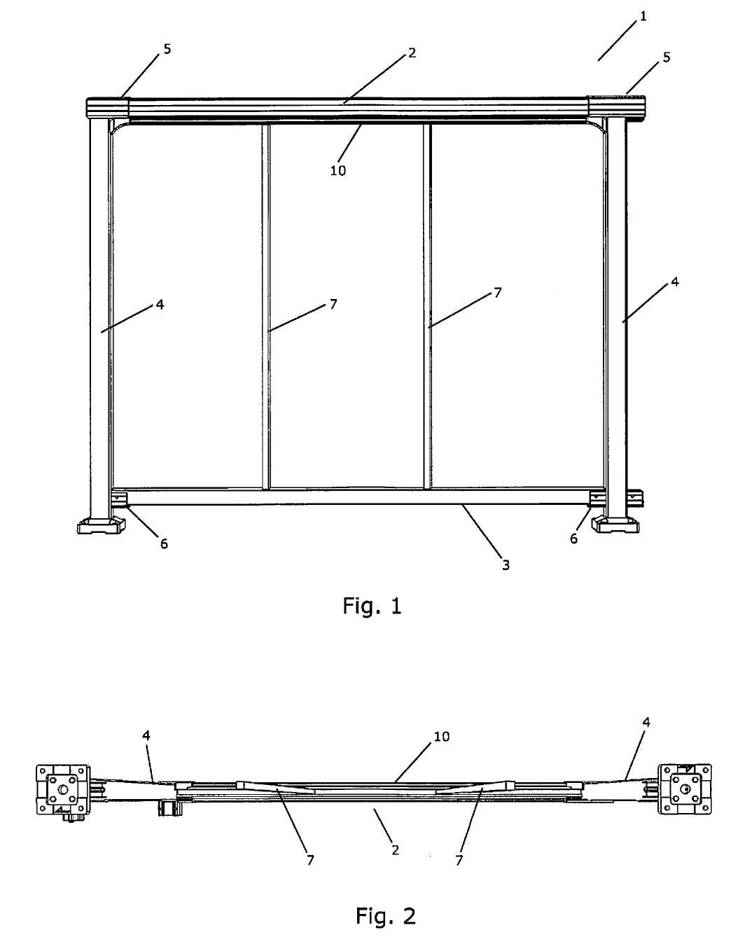

Referring to FIG. 1, an accessory holder 10 according to the present invention is attached to an exemplary railing system 1. The railing system 1 comprises one or more upper railings 2 and lower railings 3 spanning one or more substantially vertical posts 4. In the railing system 1 depicted in FIG. 1, the posts 3 comprise open-ended heads 5 and lower rail supports 6 shaped to receive the upper railings 2 and lower railings 3, respectively. However, it is understood that other means of connecting the upper and lower railings 2, 3 to the posts 4 are also possible, such as by connectors or brackets. In addition, one or more substantially vertical pickets 7 may also span the upper and lower railings 2, 3.

The accessory holder 10 is preferably attached to one or both of the upper and lower railings 2, 3 and extends for at least a portion of their lengths. For example, in the embodiments shown in FIGS. 1 to 3, the accessory holder 10 is attached to the underside of the upper railing 2 and extends for almost the entire length of the upper railing 2, save for the ends of the upper railing 2. The accessory holder 10 may be cut to length to accommodate railings 2, 3 of various lengths. Alternatively, instead of a single, long accessory holder 10 attached to the railings 2, 3, a number of shorter accessory holders 10 may be attached to the railings 2, 3 (e.g. attached in a substantially end-to-end arrangement along the railings 2, 3).

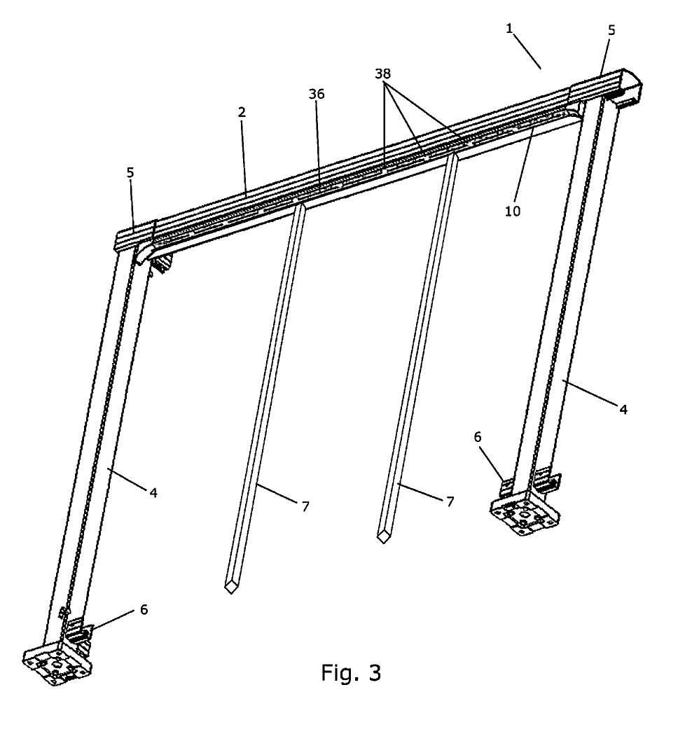

Furthermore, the accessory holder 10 is preferably attached in such a manner as to not interfere with the pickets 7. By way of example, in the embodiment shown in FIGS. 1 to 3, the pickets 7 extend approximately along the midlines of railings 2, 3. Therefore, it is preferable that the accessory holder 10 be attached proximal to one of the sides of the railings 2, 3, especially if the accessory holder 10 is attached to the underside of the upper railing 2 or to the upper side of the lower railing 3. In FIGS. 2 and 3, the lower railings 3 have been removed for ease of viewing.

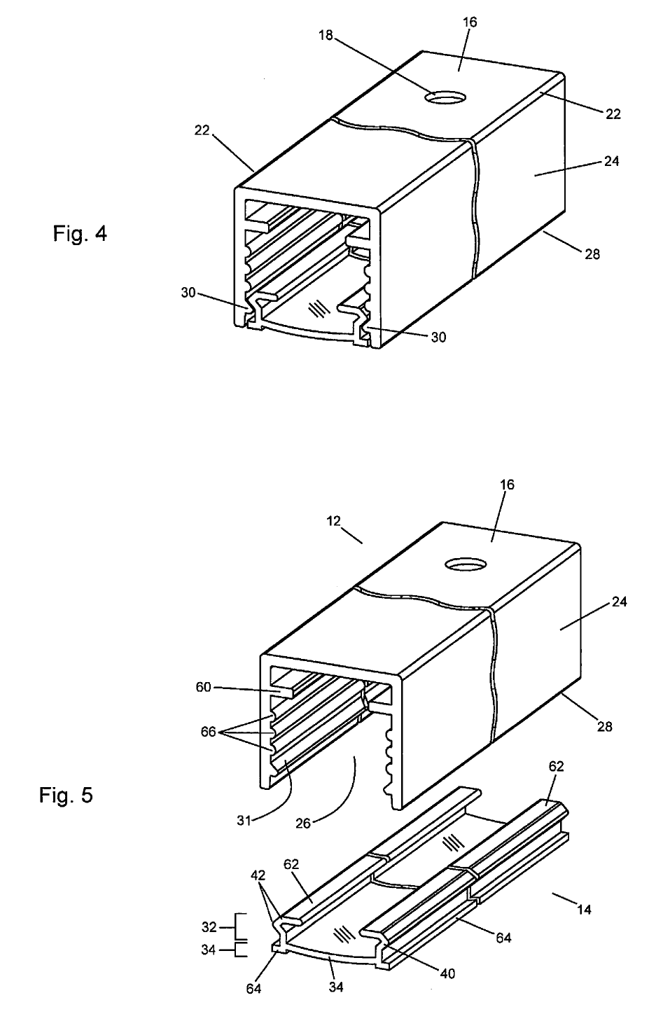

Referring to FIGS. 4 to 7, the accessory holder 10 comprises an elongated rail 12 and an elongated cap 14. The rail 12 is preferably made from a metal (e.g. aluminum), while the cap 14 is preferably made from a more pliable material (e.g. plastic). In FIGS. 4 and 5, the rail 12 and the cap 14 are shown broken in the middle to signify that they may be any length (and may accordingly be cut to length, as discussed earlier).

The rail 12 comprises a substantially planar portion 16. The planar portion 16 comprises one or more openings 18 that extend through the planar portion 16. The openings 18 are sized and adapted to receive fasteners 20 (as in FIG. 8) that secure the planar portion 16 to the railings 2, 3. The fasteners 20 may include screws, bolts, or the like.

Preferably, the planar portion 16 further comprises two longitudinal edges 22. One or more surfaces 24 extend from each of the longitudinal edges 22. In the embodiment shown in FIGS. 4 and 5, one surface 24 extends from each of the longitudinal edges 22 for substantially the entire length of the planar portion 16. Alternatively, instead of a single surface 24 extending for substantially the entire length of the planar portion 16, there may be a number of shorter surfaces 24 extending from the longitudinal edges 22 (e.g. arranged in a substantially end-to-end manner or in a spaced configuration).

In another embodiment, the surfaces 24 may extend from the planar portion 16 a distance away from the longitudinal edges 22, such that the planar portion 16 is wider than the distance between the surfaces 24.

Preferably, the surfaces 24 extend substantially perpendicularly from the planar portion 16, as shown in FIGS. 4 and 5. The surfaces 24 and the planar portion 16 generally define an open channel 26. The surfaces 24 comprise a lower edge 28 and a ridge 30. The ridge 30 is located preferably between the lower edge 28 and the longitudinal edge 22 (i.e. where the surface 24 meets with the planar portion 16). The ridge 30 may be generally triangular in cross-section (as depicted in FIGS. 4 to 7) or it may be some other shape (e.g. rounded) that protrudes into the interior of the channel 26. In this manner, the ridges 30 on opposed surfaces 24 are oriented towards each other, facing inwardly into the channel 26. Preferably, the ridges 30 on opposed surfaces 24 are aligned with each other (i.e. the distances between the longitudinal edge 22 and the ridge 30 on either of the opposed surfaces 24 are approximately the same). Referring back to FIG. 5, where the ridge 30 is generally triangular, an angled surface 31 may be present.

Preferably, the ridge 30 extends for the length of the surface 24. Alternatively, instead of a single ridge 30 extending for substantially the entire length of the surface 24, there may be a number of shorter ridges 30 (e.g. arranged in a substantially end-to-end manner or in a spaced configuration).

Preferably, an upper shelf 60 extends from the surface 24 into the interior of the channel 26. The upper shelf 60 may extend generally perpendicularly to the surface 60 such that it is parallel to, and spaced apart from, the planar portion 16. Preferably, the upper shelf 60 extends from the surface 24 somewhere between the longitudinal edge 22 and the ridge 30. In the embodiment shown in FIGS. 4 and 5, the upper shelves 60 on opposed surfaces 24 are oriented towards each other, facing inwardly into the channel 26. Preferably, the upper shelves 60 on opposed surfaces 24 are aligned with each other (i.e. the distances between the longitudinal edge 22 and the upper shelf 60 on either of the opposed surfaces 24 are approximately the same).

Preferably, the upper shelf 60 extends for the length of the surface 24. Alternatively, instead of a single upper shelf 60 extending for substantially the entire length of the surface 24, there may be a number of shorter upper shelves 60 (e.g. arranged in a substantially end-to-end manner or in a spaced configuration).

The surface 24 may also comprise one or more protrusions 66. These protrusions 66 preferably run substantially parallel to the ridges 30 and extend into the interior of the channel 26. In this manner, the protrusions 66 on the opposed surfaces 24 are oriented towards each other, facing inwardly into the channel 26. Preferably, the protrusions 66 on opposed surfaces 24 are aligned with each other (i.e. each protrusion 66 has a corresponding protrusion 66 on the opposed surface 24).

The cap 14 may be fitted onto the rail 12 and comprises an attachment portion 32 and a cover 34. The cover 34 is at least partially translucent, and preferably transparent. The attachment portion 32 may also be translucent or transparent.

Referring again to FIGS. 4 to 7, the attachment portion 32 helps to secure the cap 14 to the rail 12. Preferably, the attachment portion 32 comprises a plurality of attachment surfaces 40. In the embodiment shown in FIGS. 4 to 7, the cap 14 comprises two opposed attachment surfaces 40, with each of the attachment surfaces 40 extending for substantially the entire length of the cap 14. Alternatively, instead of the attachment surfaces 40 extending for substantially the entire length of the cap 14, there may be a number of shorter attachment surfaces 40, each extending for a portion of the length of the cap 14 (e.g. arranged in a substantially end-to-end manner or in a spaced configuration).

The attachment surfaces 40 are preferably contoured or shaped in such a way as to engage with the ridges 30. The contouring or shaping may be effected by one or more bends 42 in the attachment surfaces 40. In the embodiment shown in FIGS. 4 to 7, the attachment surfaces 40 each comprise two bends 42, such that when the cap 14 is fitted onto the rail 12, at least a portion of the attachment surface 40 rest on the angled surfaces 31. The two bends 42 result in the attachment surface 40 having at least an upper bent section 43 and a lower bent section 45. Other arrangements of the attachment surfaces 40 may be possible, depending on the shape and orientation of the ridges 30. Preferably, the geometry of the attachment surfaces 40 and the geometry of the ridges 30 allow for the attachment surfaces 40 to slide longitudinally along the ridges 30.

Preferably, a lower shelf 62 extends from the attachment surfaces 40. The lower shelves 62 on opposed attachment surfaces 40 extend towards each other, as shown in the embodiment of FIGS. 4 to 7. Furthermore, the lower shelves 62 on opposed attachment surfaces 40 are preferably aligned with each other (i.e. the lower shelves 62 lie on substantially the same plane). The space between the lower shelves 62 on opposed attachment surfaces 40 defines an opening 56.

Preferably, the lower shelf 62 extends for the length of the cap 14. Alternatively, instead of a single lower shelf 62 extending for substantially the entire length of the cap 14, there may be a number of shorter lower shelves 62 (e.g. arranged in a substantially end-to-end manner or in a spaced configuration).

The cover 34 is attached to the attachment surfaces 32 of the attachment portion 32. In one embodiment, the cover 34 is integrally formed with the attachment surfaces 32. In the embodiment shown in FIGS. 4 to 7, the attachment surfaces 40 extend substantially perpendicularly from the top surface of the cover 34. The cover 34 may extend beyond the attachment surfaces 40, as seen in the embodiment shown in FIGS. 4 to 7. In addition, the cover 34 may be substantially flat, or it may be curved or contoured. For example, in the embodiment shown in FIGS. 4 to 7, the cover 34 has a slight curvature in the middle, with a slight ledge 64 present on each of the ends of the cover 34. The ledges 64 may engage, or contact, with the surfaces 24.

Preferably, the cover 34 extends for the length of the cap 14. Alternatively, instead of a single cover 34 extending for substantially the entire length of the cap 14, there may be a number of shorter covers 34 (e.g. arranged in a substantially end-to-end manner or in a spaced configuration).

In one embodiment, the ridge 30 may engage a portion of the attachment surface 40 and a portion of the cover 34.

When the cap 14 is fitted onto the rail 12, an elongated compartment 52 is generally defined. The compartment 52 is defined, at least in part, by the cover 34, the surfaces 24, and the planar portion 16. The compartment 52 accommodates an accessory (such as a light strip 36 comprising one or more illumination sources 38). Although the compartment 52 extends from the planar portion 16 to the cover 34, the light strip 36 is preferably located between the upper shelves 60 and the lower shelves 62.

Referring to FIG. 8, the width of the light strip 36 is preferably greater than the width of the opening 56 but less than the width of the compartment 52, such that when the light strip 36 is situated horizontally within the compartment 52, the light strip 36 will rest on the lower shelves 62. The protrusions 66 may also assist in holding the light strip 36 in place within the compartment 52 and may also act to reduce rattling of the light strip 36 within the compartment 52. The upper shelves 60 may assist during insertion of the light strip 36 to prevent the light strip 36 from resting at an angle.

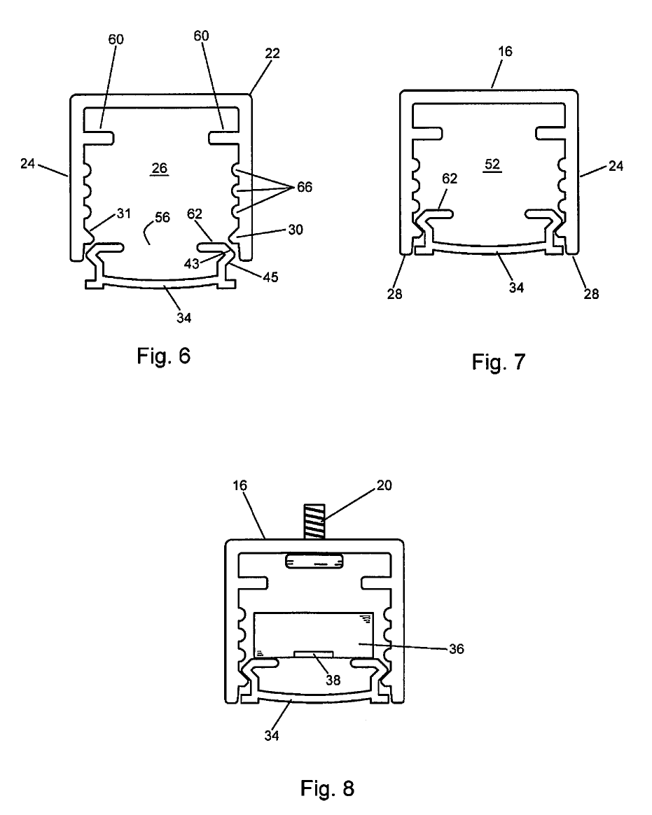

As discussed above, the cap 14 is preferably made from a more pliable material, such as plastic. The pliability of the material allows for easier insertion of the cap 14 onto the rail 12. Referring to FIGS. 6 and 7, initially, the cap 14 and the rail 12 are separate (e.g. as shown generally in FIG. 6). The light strip 36 can then be inserted into the channel 26. To attach the cap 14 into the rail 12, the cap 14 is positioned at the mouth of the channel 26, with the attachment surfaces 40 just below the ridges 30. Because the ridges 30 protrude into the interior of the channel 26, the ridges 30 will prevent the upper bent section 43 of the attachment surfaces 40 from freely passing further into the channel 26. However, since the cap 14 is made from a pliable material, an upward application of force by the attachment surfaces 40 against the ridges 30 will cause the upper bent sections 43 (and consequently the attachment surfaces 40 as a whole) to be forced inward together slightly (because of the angled orientation of the upper bent sections 43) and to slide along the ridges 30. As the upper bent sections 43 slide along the ridges 30, the upper bent sections 43 (and the attachment surfaces 40) are forced together more and more. After the upper bent sections 43 have slid past the ridges 30, the attachment surfaces 40 revert back to their original postures, and the lower bent sections 45 engage the ridges 30. Because of the angled orientation of the lower bent sections 45 (different from that of the upper bent sections 43), the cap 14 is held in place within the rail 12, as shown in FIG. 7.

In order to remove the cap 14 from the rail portion 12, sufficient downward force must be applied on the cap 14 such that the lower bent sections 45 (and consequently the attachment surfaces 40 as a whole) are forced inward together. As downward force is continued to be applied, the lower bent sections 45 slides down the angled surfaces 31 while at the same time, the lower bent sections 45 (and the attachment surfaces 40) continue to be forced together. After the lower bent sections 45 have slid past the angled surfaces 31, the upper bent sections 43 can then be easily slid past the ridges 30. The cap 14 is now free from the rail 12.

The size of the compartment 52 allows for the accommodation of light strips 36 of various thicknesses. Because the compartment 52 is enclosed on the sides by the surfaces 24 and on the bottom by the cover 34, much of the light strip 36 is protected from the elements and protected from view; however, the translucent or transparent nature of the cover 34 still allows for light to radiate from the accessory holder 10 through the cover 34.

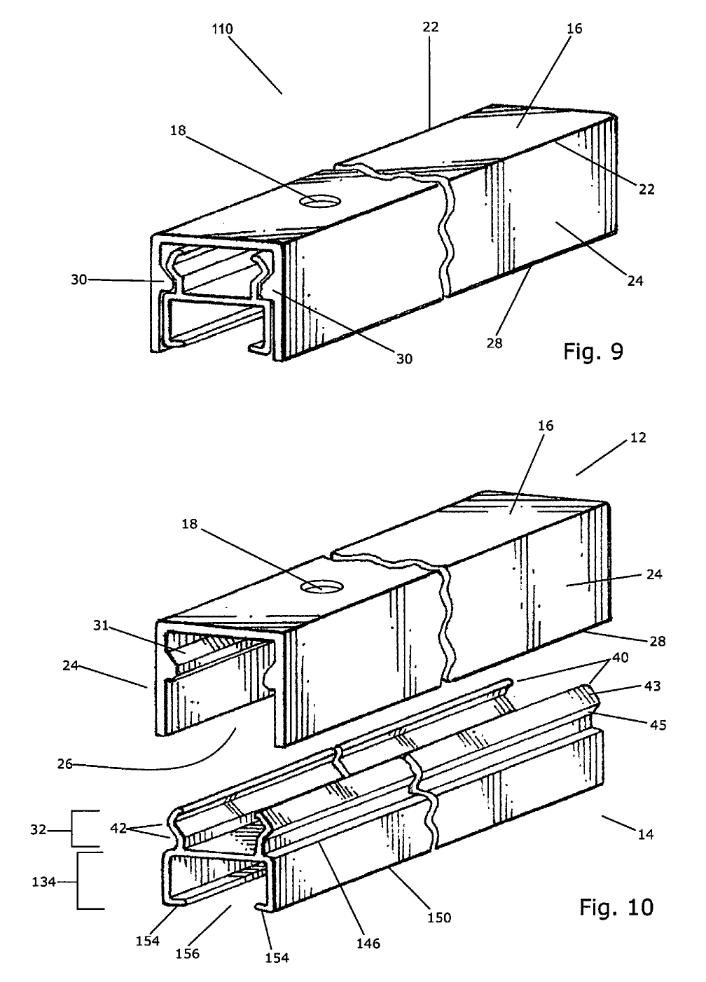

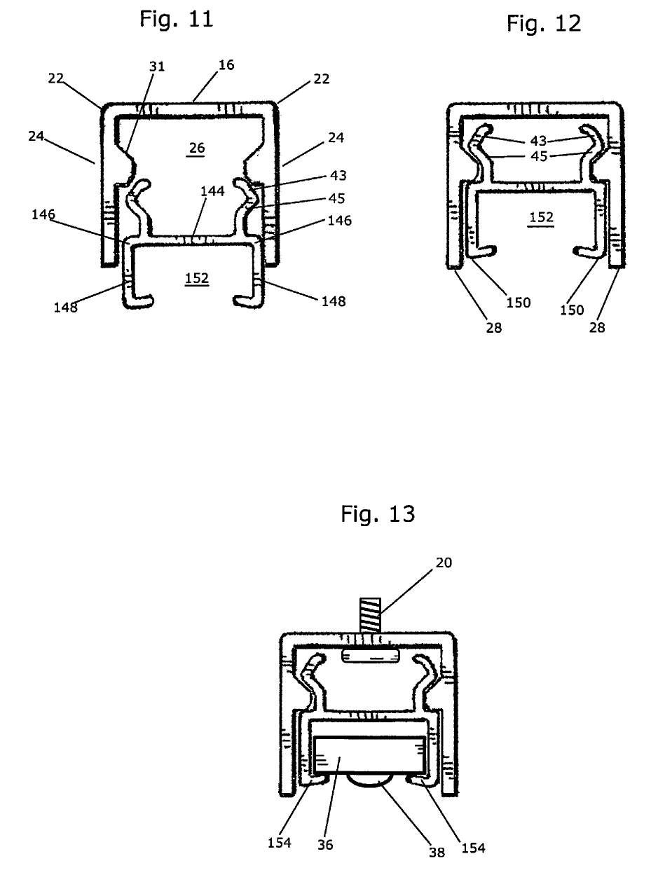

FIGS. 9 to 13 show another embodiment of the present invention. The accessory holder 110 of the embodiment shown in FIGS. 9 to 13 also comprises elongated rail 12 and elongated cap 14.

The rail 12 of the embodiment in FIGS. 9 to 13 is similar to the rail 12 of the embodiment in FIGS. 1 to 8, with a substantially planar portion 16. The planar portion 16 similarly comprises one or more openings 18 sized and adapted to receive fasteners 20 (as in FIG. 13) that secure the planar portion 16 to the railings 2, 3.

As with the embodiment shown in FIGS. 1 to 8, the planar portion 16 of FIGS. 9 to 13 further comprises two longitudinal edges 22. One or more surfaces 24 extend, preferably substantially perpendicularly, from each of the longitudinal edges 22. In FIGS. 9 to 13, one surface 24 extends from each of the longitudinal edges 22 for substantially the entire length of the planar portion 16. The surfaces 24 and the planar portion 16 generally define an open channel 26. The surfaces 24 comprise lower edge 28 and ridge 30, with the ridge 30 located between the lower edge 28 and the longitudinal edge 22. Angled surface 31 may be present on each of the ridges 30. The ridges 30 on opposed surfaces 24 are oriented towards each other, facing inwardly into the channel 26. The ridges 30 are also preferably aligned with each other. However, in the embodiment shown in FIGS. 9 to 13, the upper shelves 60 and the protrusions 66 are not present.

In the embodiment shown in FIGS. 9 to 13, the cap 14 may be fitted onto the rail 12 and comprises an attachment portion 32 (similar to that of the embodiment shown in FIGS. 1 to 8). However, instead of cover 34, the cap 14 comprises a slot portion 134 with a slot 152. The slot 152 is at least partially open on one side. The slot 152 may accommodate one or more light strips 36.

Referring again to FIGS. 9 to 13, the slot portion 134 is attached to the attachment portion 32. The slot portion 134 preferably comprises a slot upper wall 144 with slot upper edges 146. The attachment surfaces 40 of the attachment portion 32 may be fixedly attached to the slot upper wall 144, as shown in FIGS. 9 to 12. In addition, the attachment surfaces 40 may extend substantially perpendicularly from the top of the slot upper wall 144. Preferably, the attachment surfaces 40 extend a distance away from the slot upper edges 146. However, the attachment surfaces 40 are preferably not so far away from the slot upper edges 146 that they interfere with the fasteners 20. For example, if screws are used as the fasteners 20, the heads may be located on the inner surface of the planar portion 16. If the attachment surfaces 40 extend too far away from the slot upper edges 146 (i.e. too close to the center of the slot upper wall 144), the upper ends of the attachment surfaces 40 may come into contact with and interfere with the fasteners 20.

Referring to FIGS. 9 and 13, the ridge 30 may engage both a portion of the attachment surface 40 and a portion of the slot upper wall 144.

The slot portion 134 further comprises one or more slot side walls 148 extending from the slot upper wall 144 in a generally opposite direction from the attachment surfaces 40. Preferably, the slot side walls 148 extend substantially perpendicularly from the slot upper wall 144 at or proximate to the slot upper edges 146. In the embodiment shown in FIGS. 9 to 13, there are two opposed slot side walls 148, each extending for substantially the entire length of the cap 14. Alternatively, instead of the slot side walls 148 extending for substantially the entire length of the cap 14, there may be a number of shorter slot side walls 148, each extending for a portion of the length of the cap 14 (e.g. arranged in a substantially end-to-end manner or in a spaced configuration). The slot side walls 148 comprise slot lower edges 150.

Preferably, when the cap 14 is fitted within the rail 12, the slot side walls 148 will either engage with or be in close proximity to the surfaces 24. Furthermore, the surfaces 24 will preferably extend beyond the slot lower edges 150 of the slot side wall 148, thereby hiding much of the cap 14 from view.

The slot upper wall 144 and the slot side walls 148 generally define the slot 152 that accommodates the light strip 36. In order to prevent the light strip 36 from falling out of the slot 152, the slot portion 134 may also comprise one or more lips 154. The lips 154 extend from the slot side walls 148 and inwardly into the slot 152. Preferably, the lips 154 extend from the slot side walls 148 at the slot lower edges 150 and extend slightly upwardly. However, it is possible that the lips 154 extend a distance away from the slot lower edges 150. In the embodiment shown in FIGS. 9 to 13, there are two lips 154, each extending for substantially the entire length of the cap 14. Alternatively, instead of the lips 154 extending for substantially the entire length of the cap 14, there may be a number of shorter lips 154, each extending for a portion of the length of the cap 14 (e.g. arranged in a substantially end-to-end manner or in a spaced configuration). The lips 154 define a slot opening 156.

Referring to FIG. 13, the width of the light strip 36 is preferably greater than the width of the slot opening 156 but less than the width of the slot 152, such that when the light strip 36 is situated horizontally within the slot 152, the light strip 36 will not fall out. Instead, the light strip 36 would be prevented from falling out by the lips 154.

The relative pliability of the cap 14 allows for the insertion of the light strip 36. The light strip 36 may be inserted into the slot 152 by placing the light strip 36 at the slot opening 156 and applying an upward force on the light strip 36. This upward force will cause the lips 154 to deflect upwards and cause the sides of the light strip 36 to slide along the lips 154. Once the light strip 36 has slid past the lips 154, the lips 154 will revert to their original postures, and the light strip 36 will be prevented from falling out of the slot 152 by the lips 154.

In the embodiment shown in FIGS. 9 to 13, it is envisioned that the insertion and removal of the cap 14 from the rail 12 will happen less often than the insertion and removal of the light strip 36 from the cap 14. Accordingly, the cap 14 may be made from at least two different pliable materials. The attachment surfaces 40 are made from a less pliable material than the lips 154. For example, the attachment surfaces 40 may be made from a rigid plastic, while the lips 154 may be made from a more flexible form of plastic.

The size of the slot 152 allows for the accommodation of light strips 36 of various thicknesses. Because the slot 152 is enclosed on the side by the slot side walls 148, much of the light strip 36 is hidden from view; however, the slot opening 156 still allows for light to radiate from the accessory holder 110.

Since the cap 14 is separated into the attachment portion 32 and the slot portion 134, the light strips 36 can be placed physically closer to the slot opening 156, potentially allowing more light to be radiated from the accessory holder 110.

In another embodiment of the invention, instead of light strips 36, the accessory holder 10 may be adapted to hold other accessories for the railing system 1. For example, the compartment 52 and the cap 14 may be adapted to hold one or more hooks or hangers, including but not limited to flower holders, drink holders, towel hooks, and umbrella holders. These hooks or hangers may be used to hang ornaments or other items from the accessory holder 10.

In a further embodiment, the accessory holder 10, 110 may be attached to other structures besides railings 2, 3. For example, the accessory holder 10, 110 may be attached to a banister or a handrail. Furthermore, the accessory holder 10, 110 may also be attached to a beam or a table. The accessory holder 10, 110 may be attached to any suitable structure capable of receiving the fasteners 20 through the openings 18.

It will be appreciated by those skilled in the art that the preferred embodiment has been described in some detail but that certain modifications may be practiced without departing from the principles of the invention.

1. An apparatus for securing an accessory to a structure, said apparatus comprising:
a first elongated member comprising:
a planar portion comprising one or more openings adapted to receive fasteners for attachment of said planar portion to said structure; and
a plurality of surfaces extending from said planar portion, each of said surfaces comprising a substantially longitudinal ridge;
wherein said planar portion and said surfaces define a channel, and wherein said ridges extend inwardly into said channel; and
a second elongated member fitted in said channel, comprising:
a cover; and
an attachment portion comprising a plurality of attachment surfaces, wherein each of said attachment surfaces is contoured to engage with one of said ridges, and wherein said attachment surfaces are attached to said cover;
wherein said first and second elongated members define a compartment for holding said accessory, and wherein said compartment is defined, at least in part, by said planar portion, said surfaces, and said cover.

2. (canceled)

3. (canceled)

4. (canceled)

5. (canceled)

6. The apparatus of claim 1, wherein said first elongated member is made from a first material and said second elongated member is made from a second material, and wherein said second material is more pliable than said first material.

7. (canceled)

8. (canceled)

9. The apparatus of claim 1, wherein said ridges on opposing said surfaces are aligned with each other.

10. The apparatus of claim 1, wherein said surfaces further comprise an upper shelf extending into said channel, and wherein said upper shelf extends from said surface in between said upper edge and said ridge.

11. The apparatus of claim 10, wherein said upper shelves extend substantially parallel to said planar portion.

12. The apparatus of claim 10, wherein said upper shelves on opposing said surfaces are aligned with each other.

13. The apparatus of claim 10, wherein said surfaces further comprise one or more protrusions extending substantially parallel to said ridges and extending into said channel.

14. The apparatus of claim 13, wherein said protrusions on opposing said surfaces are aligned with each other.

15. The apparatus of claim 1, wherein said cover is at least partially translucent.

16. (canceled)

17. The apparatus of claim 1, wherein said attachment surfaces slidably engage with said ridges.

18. (canceled)

19. The apparatus of claim 1, wherein said attachment surfaces are adapted to bend inwardly when a force substantially perpendicular to a longitudinal axis of said second elongated member is applied on said attachment surfaces and wherein said attachment surfaces are adapted to revert to an original orientation when said force is no longer applied.

20. (canceled)

21. The apparatus of claim of claim 1, wherein said attachment surfaces comprise a lower shelf, and wherein said lower shelf extends into said channel.

22. (canceled)

23. (canceled)

24. (canceled)

25. (canceled)

26. (canceled)

27. (canceled)

28. (canceled)

29. The apparatus of claim 1, wherein said ridge engages a portion of said attachment surface and a portion of said cover.

30. A holder of a light strip for a railing, said holder comprising:
a rail comprising:
a planar portion comprising one or more openings adapted to receive fasteners for attachment of said planar portion to said railing; and
a plurality of surfaces extending from said planar portion, each of said surfaces comprising a substantially longitudinal ridge;
wherein said planar portion and said surfaces define a channel, and wherein said ridges extend inwardly into said channel; and
a cap fitted in said channel, comprising:
a cover; and
an attachment portion comprising a plurality of attachment surfaces, wherein each of said attachment surfaces is contoured to engage with one of said ridges, and wherein said attachment surfaces are attached to said cover;
wherein said rail and said cap define a compartment for holding said light strip, and wherein said compartment is defined, at least in part, by said planar portion, said surfaces, and said cover.

31. The holder of claim 30, wherein each of said surfaces comprise an upper edge and a lower edge, and wherein said ridge extends in between said upper and lower edges.

32. The holder of claim 31, wherein said surfaces further comprise an upper shelf extending into said channel, and wherein said upper shelf extends from said surface in between said upper edge and said ridge.

33. The holder of claim 32, wherein said attachment surfaces comprise a lower shelf, and wherein said lower shelf extends into said channel.

34. (canceled)

35. An apparatus for securing an accessory to a structure, said apparatus comprising:
a first elongated member comprising:
a planar portion comprising one or more openings adapted to receive fasteners for attachment of said planar portion to said structure; and
a plurality of surfaces extending from said planar portion, each of said surfaces comprising:
upper and lower edges; and
a substantially longitudinal ridge extending in between said upper and lower edges;
wherein said planar portion and said surfaces define a channel, and wherein said ridges extend inwardly into said channel; and
a second elongated member fitted in said channel, comprising:
a slot portion comprising a slot for holding said accessory, wherein said slot is at least partially open on one side; and
an attachment portion comprising a plurality of attachment surfaces, wherein each of said attachment surfaces is contoured to engage with one of said ridges, and wherein said attachment surfaces are attached to said slot portion.

36. The apparatus of claim 35, wherein said slot portion further comprises a slot upper wall and one or more slot side walls extending from said slot upper wall.

37. (canceled)

38. The apparatus of claim 35, wherein said ridges are in contact with at least a portion of at least one of said attachment surfaces and with at least a portion of said slot upper wall.

39. (canceled)

40. (canceled)
